(19) United States
(12) Patent Application Publication
(10) Pub. No.: US 2013/0042432 A1
(43) Pub. Date: Feb. 21, 2013

(54) SPRING-BIASED HINGED ASSEMBLY

(71) Applicants: Stuart John Andrews, Deakin (AU); Mark Cumming, New South Wales (AU)

(72) Inventors: Stuart John Andrews, Deakin (AU); Mark Cumming, New South Wales (AU)

(21) Appl. No.: 13/578,369

(22) PCT Filed: Feb. 10, 2011
(86) PCT No.: PCT/AU11/00132

§ 371 Date: Oct. 26, 2012

(30) Foreign Application Priority Data
Feb. 12, 2010 (AU) 2010900570

(51) Int. Cl. E05F 3/20; E05F 1/12

(52) U.S. Cl. 16/50

(57) ABSTRACT

A spring-biased hinged assembly (10) including a spool (30) associated with a first hinged member (20) a spring (70) associated with a second hinged member (60) and a tensile member (100) extending from the spool (30) to the spring (70).

This International Application claims priority from Australian Provisional Patent Application 2010900570 which is hereby incorporated in its entirety by cross-reference.

### FIELD OF THE INVENTION

The present invention relates to a spring-biased hinged assembly. The spring-biased hinged assembly is particularly suitable for use in mounting a gate that is biased towards the closed position via a closing torque. Such self-closing gates may be associated with, for example, swimming pools and child care centers. Such gates are typically automatically latched when they reach the closed position such that the default configuration is for the gate to be both closed and securely latched. The invention will herein be described in a non-limiting manner with reference to this specific field of use.

### BACKGROUND OF THE INVENTION

The use of spring-biased hinged assemblies for self-closing gates is known. A problem with these hinged assemblies is that the gate tends to slam shut when it is released from the fully open position (“long range closing”) and then allowed to accelerate under the influence of the closing torque produced by the spring. This can be dangerous to users of the gate and it can also damage the gate or latching components.

It is not a viable solution to use a weak spring, because it is important that the spring produce enough closing torque to close the gate when the gate is released from adjacent to the closed position (“close-range closing”). Indeed, known spring-biased hinged assemblies usually have some means for increasing the pre-load on the spring as the spring weakens or relaxes over time to ensure that there remains an adequate closing torque for close-range closing.

The present invention aims to provide a novel spring-biased hinged assembly. In the preferred embodiment, which is designed for use with self-closing gates, the invention provides sufficient torque to ensure reliable close-range closing whilst at the same time addressing the slamming problem associated with long-range closing.

### SUMMARY OF THE INVENTION

The present invention provides a spring-biased hinged assembly and a method of converting spring force into torque in a spring-biased hinged assembly as defined in the claims.

Other preferred features of the various aspects of the invention will be apparent from the dependant claims and from the following description of the preferred embodiments.

### BRIEF DESCRIPTION OF THE DRAWINGS

The various aspects of the invention will now be described in a non-limiting manner with respect to a preferred embodiment of the invention in which:—

FIG. 1 is a front perspective view of a spring-biased hinged assembly in situ on a gate and fence structure;

FIG. 2 is a rear perspective view of the spring-biased hinged assembly in situ on the gate and fence structure of FIG. 1.

FIG. 3 is an exploded view of the rear of the spring-biased hinged assembly;

FIG. 4 is another exploded view of the rear of the spring-biased hinged assembly;

FIG. 5 is an exploded side view of the spring-biased hinged assembly;

FIG. 6 is a front perspective view of the spring-biased hinged assembly;

FIG. 7 is a perspective view of the spring biased hinged assembly when partially opened;

FIG. 8 is another perspective view of the spring biased hinged assembly when partially opened;

FIG. 9 is a perspective view of a transverse cross section of a partially opened spring-biased hinged assembly of the present invention;

FIG. 10 is a further rear perspective view of the partially opened spring-biased hinged assembly, without mounting flanges;

FIG. 11 is a rear perspective view of the spring-biased hinged assembly in the closed position;

FIG. 12 is a perspective view of a transverse cross-section of the spring-biased hinged assembly in the closed position;

FIG. 13 is a rear perspective view of the spring-biased hinged assembly in the closed position, without mounting flanges;

FIG. 14 is a top perspective view of an alternative embodiment of the present invention;

FIG. 15 is a perspective view of a transverse cross-section of an alternative embodiment of the present invention with the spring-biased hinged assembly in the closed position;

FIG. 16 is a perspective view of a transverse cross-section of an alternative embodiment of the present invention with the spring-biased hinged assembly in a partially open position;

FIG. 17 is a top view of a transverse cross-section of an alternative embodiment of the present invention with the spring-biased hinged assembly in a partially open position;

FIG. 18 is a rear perspective view transverse cross-section of an alternative embodiment of the present invention with the spring-biased hinged assembly in a partially open position.

FIG. 19 is a perspective view of another alternative embodiment of the spring-biased hinged assembly in a partially open position;

FIG. 20 is a perspective view of a transverse cross-section of the alternative embodiment of the spring-biased hinged assembly of FIG. 19; and

FIG. 21 is a front perspective view of the alternative embodiment of the spring-biased hinged assembly of FIG. 19.

### DETAILED DESCRIPTION OF PREFERRED EMBODIMENTS

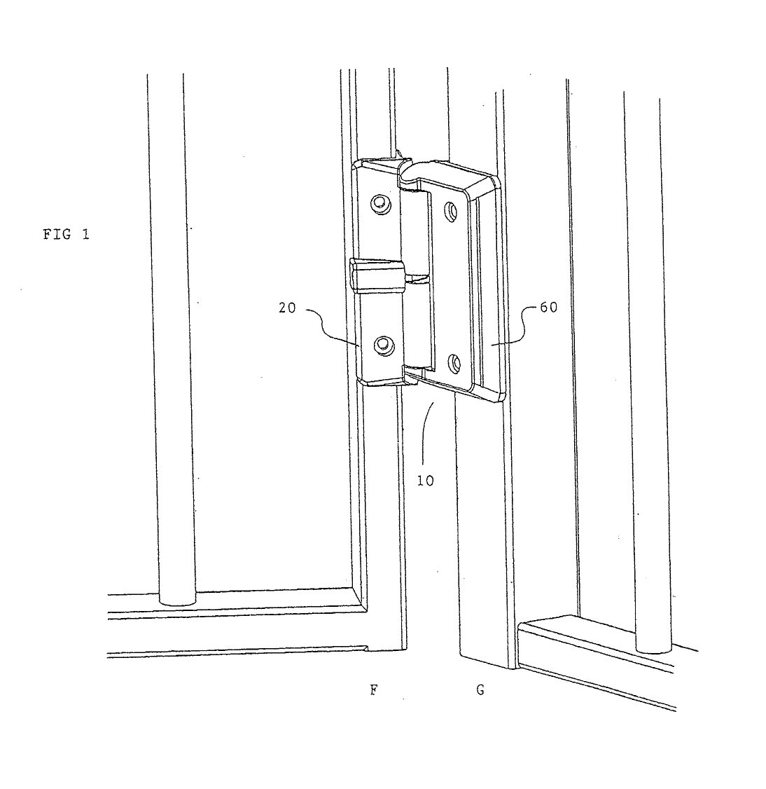

With reference to FIG. 1, the spring-biased hinged assembly 10 of a first embodiment of the present invention is shown with a first hinged member 20 mounted to a fence F, and a second hinged member 60 mounted to a gate G to allow articulation between the two hinged members, and to cause the gate G to be self closing relative to the fence F. It will be readily understood that the spring-biased hinged assembly 10 may equally be applied to any two structures requiring self closing or self opening functionality, such as for example cool room doors, or animal entry flaps mounted to residential doors, or the like.

As shown in FIG. 1, the spring-biased hinged assembly 10, protrudes minimally and presents smooth surfaces in order to minimize the ability for a child to get a foothold and climb onto the hinged assembly and potentially unlock the gate G.

The first hinged member 20 and second hinged member 60 each include apertures, which are preferably recessed into the respective hinged members. The apertures allow the first hinged member 20 to be mounted to the fence F and the second hinged member 60 to be mounted to the gate G such that the front of the spring-biased hinged assembly 10 is presented outwardly, as illustrated in FIG. 1.

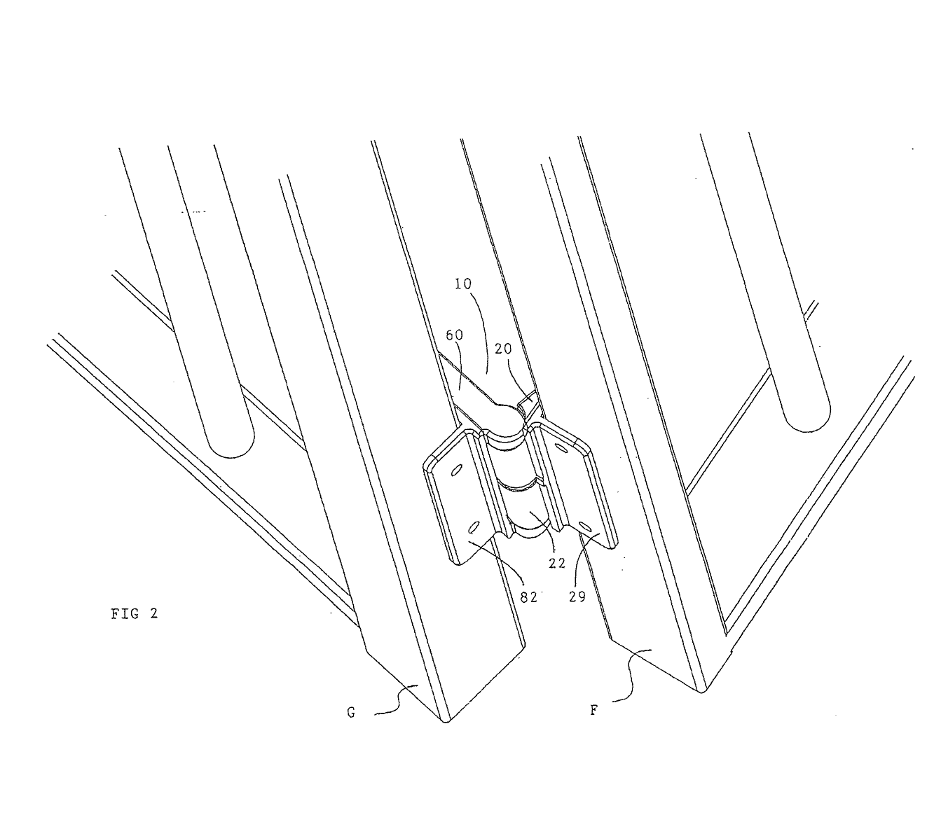

FIG. 2 illustrates a rear perspective view of the spring-biased hinged assembly 10 when the gate G is open to be approximately perpendicular to the fence F. First hinged member 20 is additionally mounted to the fence F via a first apertured mounting flange 29, whilst second hinged member 60 is additionally mounted to the gate G via a second apertured mounting flange 82. The respective flanges may be screwed, bolted or otherwise fastened to the fence or gate structures in a manner known in the art. First hinged member 20 includes a pair of cylindrical chambers 22 which contain a spring and pin arrangement (not shown in FIG. 2) to allow articulated movement between the first hinged member 20 and second hinged member 60.

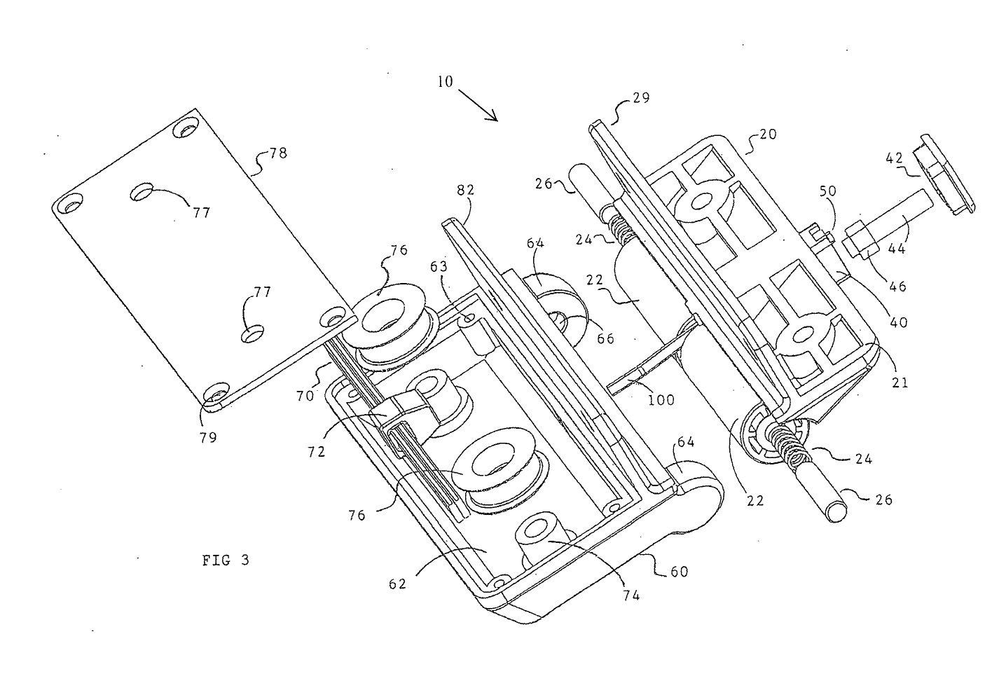

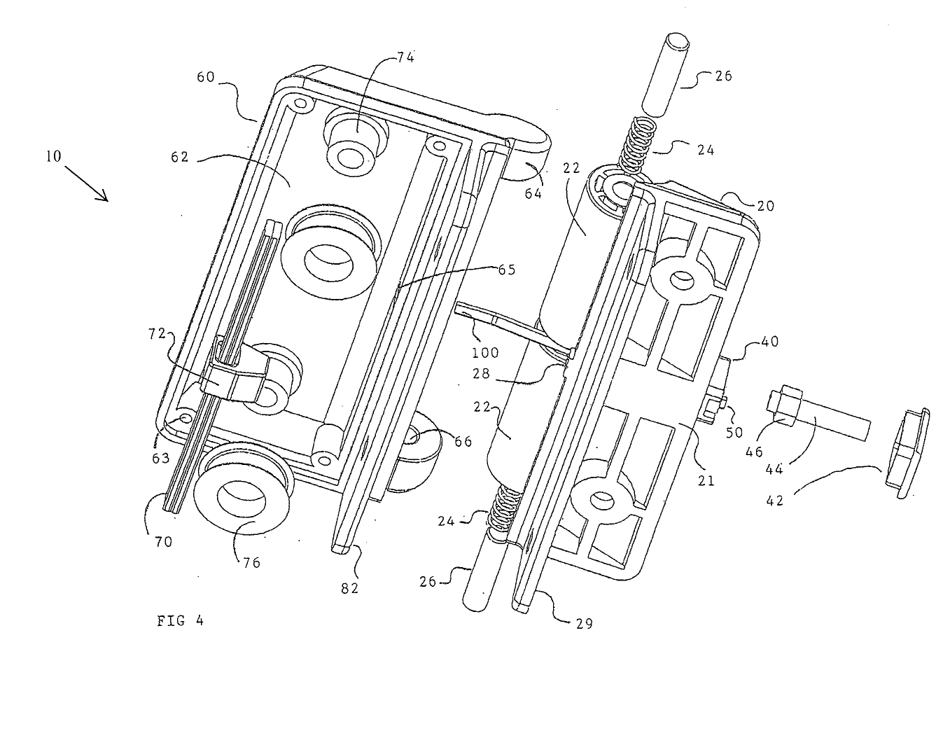

FIGS. 3 and 4 show exploded views of the rear of the spring-biased hinged assembly 10 according to the first embodiment of the invention. As can be seen, first hinged member 20 comprises an apertured base plate 21 having integrally formed therewith a first apertured mounting flange 29 which extends approximately perpendicular the apertured base plate 21. First hinged member 20 also comprises a pair of cylindrical chambers 22. Each cylindrical chamber 22 is sufficiently large enough to accommodate a compression spring 24 and a locating pin 26 which abuts the compression spring. This allows each locating pin 26 to be biased such that, when assembled, a portion of the locating pin 26 is exposed from the open end of each cylindrical chamber 22 and engages with a recess 66 for the locating pins 26.

In the present embodiment, first hinged member 20 also comprises a spool 30 (not visible in FIGS. 3 and 4) intermediate the cylindrical chambers 22. The axial space created by the spool allows tensile member 100 to fit between the cylindrical chambers and wrap over the spool on its path to a pre-tensioning chamber 40 integrally formed with the first hinged member 20.

Pre-tensioning chamber 40 allows the tension in tensile member 100 to be adjusted. The pre-tensioning chamber 40 includes an anchor block 48 (not shown in FIGS. 3 and 4) which receives tensile member 100. The anchor block may be moved within pre-tensioning chamber 40 via rotation of tensioning bolt 44 relative to captive nut 46 in order to adjust the tension in tensile member 100. In the embodiment shown in FIG. 3, a clamping screw 50 is used to fasten the tensile member to the anchor block within the pre-tensioning chamber 40. However, as will be described in more detail later, alternative fastening means may also be used. End cap 42 seals the pre-tensioning chamber 40 in order to prevent unwanted debris entering the chamber.

Second hinged member 60 includes a housing 62 having fastening apertures 63 formed thereon for mounting cover plate 78. Second hinged member 60 also includes a second apertured mounting flange 82 as an additional mounting point for the second hinged member 60. Extending from housing 62 is a pair of hinge plates 64, with each hinge plate having a recess 66 for receiving the locating pins 26 of first hinged member 20. In this manner, first hinged member 20 is able to articulate with second hinged member 60.

Housing 62 of the second hinged member 60 also contains a pair of mounting apertures 74. Each mounting aperture 74 is a hollow cylindrical shape to allow well known fastening means such as screws or bolts to pass there-through in order to secure the second hinged member 60 to a gate post as shown in FIG. 1, or other similar structures. Each mounting aperture 74 also locates a bearing 76 such that the bearing may rotate about the central axis of each mounting aperture 74.

In the embodiment shown, a pair of leaf springs 70 is held together by a leaf spring retaining sleeve 72. The leaf springs 70 are preferably constructed from a synthetic composite material which is not prone to corrosion or fatigue. Whilst a further embodiment of the present invention allows for a single leaf spring to be used, it is preferable to include multiple leaf springs 70. This avoids the possibility of a complete failure of the spring-biased hinged assembly 10 to shut, should the single leaf spring break.

Tensile member 100 passes through an opening 65 in the housing 62 of the second hinged member 60 so that one end of the tensile member 100 is fastened to leaf spring retaining sleeve 72, as will be described later.

In the embodiment of the present invention shown in FIGS. 3 and 4, each bearing 76 includes a pair of annular rims which prevent leaf springs 70 from moving axially off the surface of the bearing 76 as the bearing rotates about mounting aperture 74.

In order for the spring-biased hinged assembly 10 to present a flat surface to a gate post or panel onto which the second hinged member 60 is to be mounted, a cover plate 78 is provided. The cover plate 78 also prevents debris and the like from entering into the housing 62 of the second hinged member 60. Cover plate 78 also contains plate fastening holes 79 which are aligned with fastening apertures 63 of the housing 62 in order to fix cover plate 78 to the housing self tapping screws or the like. Additionally, cover plate 78 includes a pair of cover plate mounting apertures 77. When cover plate 78 is fastened to the housing 62, each mounting aperture 74 axially aligns with a respective cover plate mounting aperture 77. This provides a pair of fastening points to facilitate fastening of the second hinged member 60 to a gate post, fence or other structure.

In the preferred embodiment of the present invention, first and second hinged members 20, 60 and cover plate 78 are constructed from injection-moulded glass-reinforced nylon, or a similar type of polymer. Alternatively, the hinged members may be constructed from synthetic or composite material, metal, alloy or a combination thereof. Preferably, bearing 76 is also manufactured from glass-reinforced nylon.

As shown in FIG. 4, tensile member 100 passes through bore hole 28 formed in first hinged member 20. An opening 65 is formed in housing 62 of the second hinged member 60 so that the opposite end of tensile member 100 may be threaded therethrough.

Tensile member 100 may comprise a high strength synthetic cord such as braided or unbraided ultra-high molecular weight polyethylene fiber such as Dyneema®, or Spectra®. Alternatively, a high tensile stainless steel braided wire or the like may be suitable for use as a tensile member.

In addition to the features shown in FIGS. 3 and 4, FIG. 5 shows cover plate 78 including a pair of guide rails 80. The guide rails 80 prevent leaf spring retainer sleeve 72 from sliding along the length of the leaf springs 70 as tension is put on the tensile member due to articulation of the spring-biased hinged assembly 10. Linearly guiding the leaf spring retainer sleeve 72 allows tensile member 100 to be kept in alignment with the opening 65 in housing 62, the spool 30, and bore 28 of the first hinged member 20.

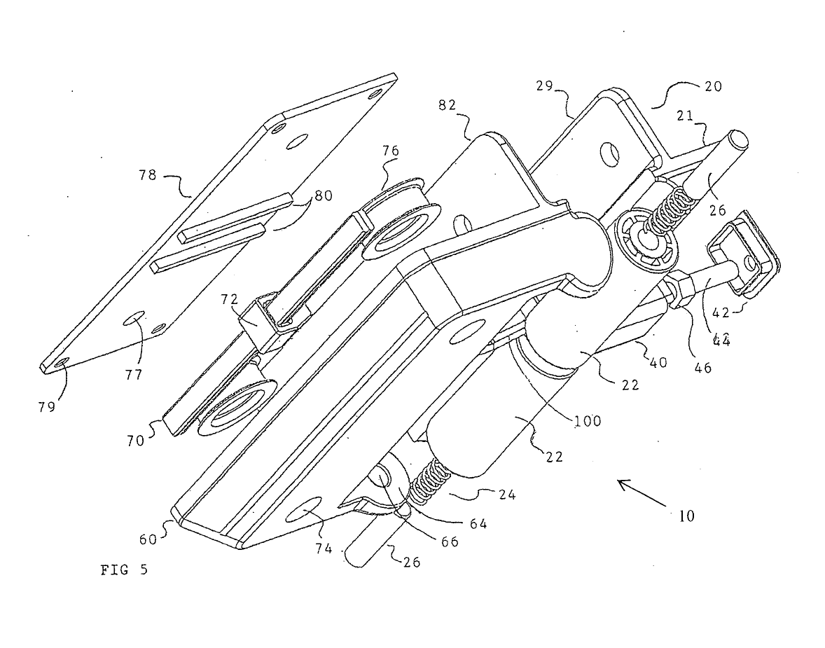

According to a preferred embodiment of the invention shown in FIG. 5, end cap 42 has an aperture therein to allow access to tensioning bolt 44. This allows easy access of an Allan key or the like, in order to rotate bolt 44 and tension tensile member 100 as previously described, without having to remove end cap 42 and expose the pre-tensioning chamber to the environment.

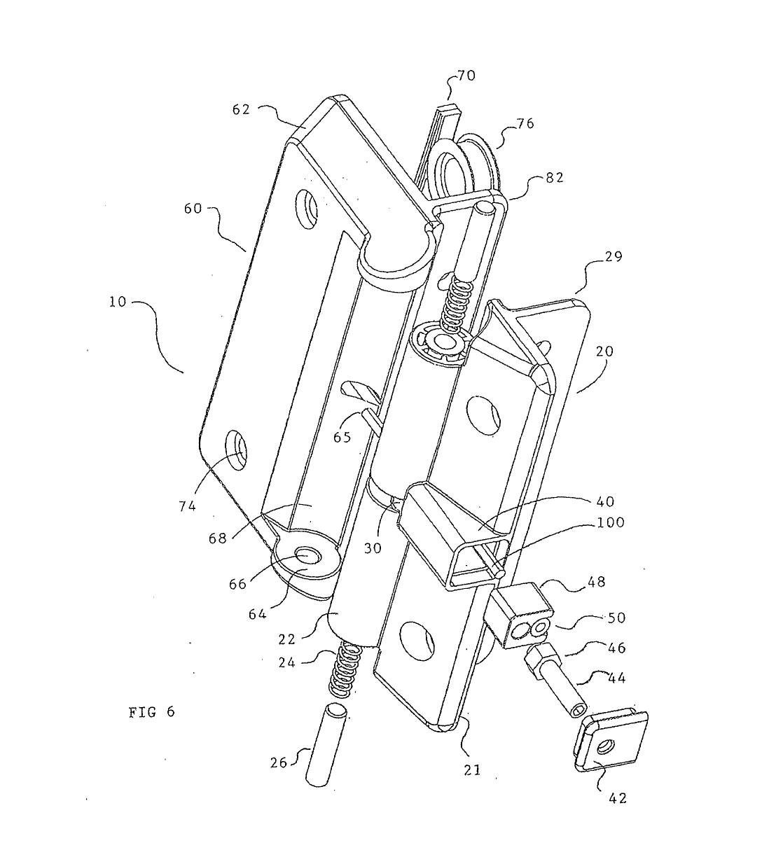

FIG. 6 illustrates a front perspective view of the spring-biased hinged assembly 10 described in FIGS. 3 and 4. For safety, both first hinged member 20 and second hinged member 60 present a low profile outer face in order to prevent children being able to gain a toe-hold on the spring-biased hinged assembly 10 and climb on the hinged assembly. Additionally, housing 62 preferably includes sloped or beveled sides in order to hinder children climbing on the spring-biased hinged assembly 10.

In addition, FIG. 6 shows housing 62 of the second hinged member 60 including a part-cylindrical recess 68 shaped to receive the cylindrical chambers 22 of first hinged member 20. In the present embodiment, opening 65 is located in the part-cylindrical recess 68 to allow tensile member 100 to pass therethrough. Opening 65 is aligned with spool 30, and the bore hole (not shown) of the first hinged member 20 so that the tensile member 100 may extend from pre-tensioning chamber 40 though the bore hole 28 of the first hinged member 20, wrap about spool 30 and pass through opening 65 with minimal deviation.

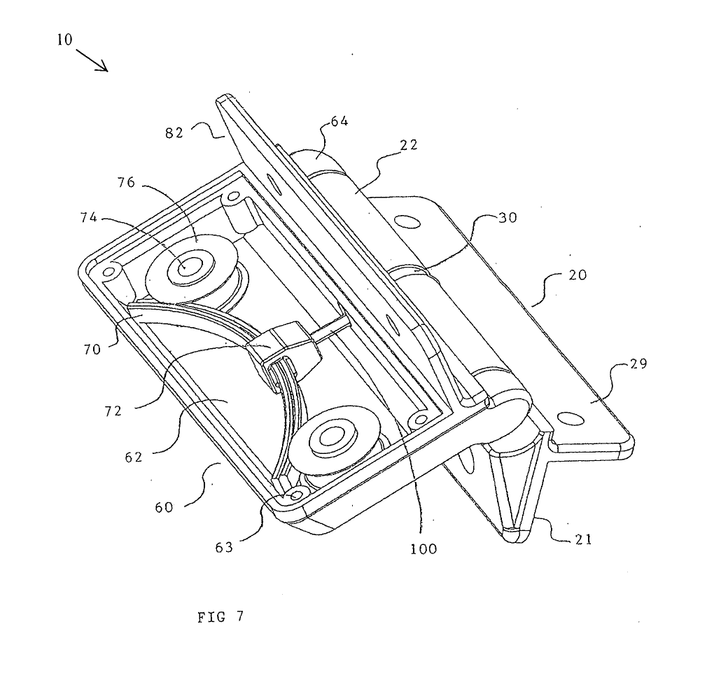

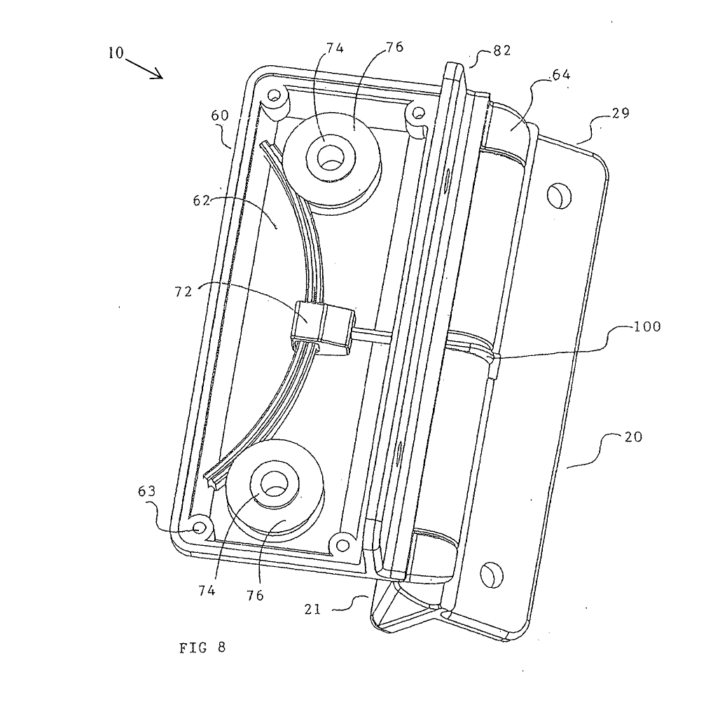

In accordance with an embodiment of the present invention, FIGS. 7 and 8 show the spring-biased hinged assembly 10 in a partially open position. As the spring-biased hinged assembly is opened, first hinged member 20 and second hinged member 60 articulate relative to each other, and tensile member 100 wraps onto spool 30 thereby placing tension on the tensile member 100, resulting in leaf springs 70 becoming loaded or flexed. As the load on leaf springs 70 increases due to the spring-biased hinged assembly 10 opening further apart, bearings 76 also rotate about mounting apertures 74.

Flexing of the leaf springs 70 provides the tension on the tensile member 100 and hence a torque to ensure the first hinged member 20 and second hinged member 60 fully articulate back to the closed position once the force opening a gate has ceased.

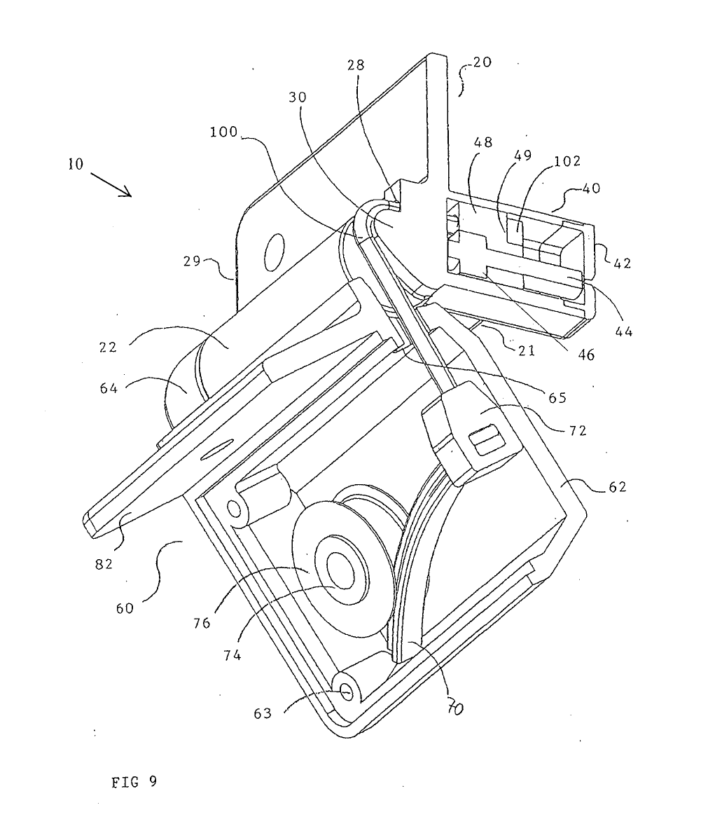

The preferred embodiment of the present invention will be described in more detail with reference to FIG. 9 which shows a transverse cross section of a partially opened spring-biased hinged assembly 10.

First hinged member 20 includes a pre-tensioning chamber 40 which contains an anchor block 48 having a seat 49. The seat 49 receives a swage 102 capping one end of tensile member 100. By turning tensioning bolt 44, captive nut 46 may move along the length of the tensioning bolt 44, resulting in anchor block 48 moving along the length of the pre-tensioning chamber 40. This movement of the anchor block 48 in turn tensions or relaxes the tensile member 100 as the seat 49 of anchor block 48 engages with swage 102 and moves the swage's relative position within the pre-tensioning chamber 40.

By adjusting the tension of the tensile member 100 in the manner described above, the leaf springs 70 may also be pre-loaded prior to the spring-biased hinged assembly 10 being opened. That is, the spring-biased hinged assembly may have a torque placed upon it to cause the first hinged member 20 and second hinged member 60 to articulate to a closed position if no other force is applied to the spring-biased hinged assembly 10.

Advantageously, pre-loading or flexing the leaf springs 70 as described above whilst the spring-biased hinged assembly is in the closed position provides the closing torque between the first hinged member 20 and second hinged member 60 required to close a gate when close-range closing of the gate is required.

As would be understood by the skilled person, the amount of load or bias placed on leaf springs 70 may be adjusted by simply rotating the tensioning bolt 44. Additionally, the torque characteristics of the spring-biased hinged assembly 10 may be altered by altering the size, number and/or type of leaf springs 70 used.

In another embodiment of the present invention not illustrated, a second spring may be fixed to the first hinged member 20 in place of the tensioning chamber 40. In this embodiment, one end of tensile member 100 is fastened to the second spring (for example a compression spring, or one or more leaf springs) located in the first hinged member 20. The other end of tensile member 100 is fastened and tightened to leaf spring retaining sleeve 72 with the desired amount of tension to pre-load the leaf springs 70 and second spring as desired.

As shown in FIG. 9, tensile member 100 passes through bore hole 28 and wraps around spool 30 before extending through opening 65 in housing 62 of the second hinged member 60. In this embodiment, spool 30 is integral with the first hinged member 20 and is shown with a cammed profile. Spool 30 is positioned intermediate the pair of cylindrical chambers 22 and is offset from the central axis of the cylindrical chambers 22.

As would be understood by those skilled in the art, alternative spool locations relative to the center of the cylindrical chamber 22 are envisaged. For example, the spool 30 may be in co-axial alignment with the cylindrical chamber. Similarly, the profile of the spool 30 may vary from cylindrical through a variety of different, or even multiple cam profiles on the spool 30. The amount of torque between the first hinged member 20 and second hinged member 60 as they articulate from an open to a closed position is a function of the load or strain on the tensile member 100, and the effective radius of the spool at the point the tensile member 100 tangentially wraps about the spool. Therefore, by adjusting the cam profile or location of the spool 30, or the tension in the tensile member 100 various torque characteristics for the spring-biased hinged assembly 10 can be achieved as the first hinged member 20 and second hinged member 60 articulate relative to each other from an open to a closed position.

As the first hinged member 20 and second hinged member 60 articulate further apart in order to open the spring-biased hinged assembly 10, more of the tensile member 100 wraps itself onto the non-cylindrical profile of spool 30 as the spool is axially rotated during articulation.

The subsequent torque characteristics of the spring-biased hinged assembly 10 are a product of the resistive force provided by the leaf springs 70 and the radius of the spool 30 at the tangential point at which the tensile member 100 contacts the spool 30.

By selectively varying the profile of spool 30, the radius of the spool 30 at which the tensile member 100 tangentially contacts the spool may be varied. Consequently, the torque characteristics of the spring-biased hinged assembly 10 may be controlled by the user.

Advantageously, the present invention allows the torque characteristics between the first hinged member 20 and second hinged member 60 to be controlled such that unwanted acceleration created by the long range closing of a gate is prevented as the spring-biased hinged assembly 10 articulates towards the closed position.

In one embodiment of the present invention, the profile of the radius of the spool 30 may be selected to provide a uniform torque as the spring-biased hinged assembly 10 articulates to a closed position. Alternatively, a spool profile may be selected to increase the torque as the spring-biased hinged assembly moves from a long range closing to a close-range closing position of a gate. As would be recognised by the skilled person, further alternative torque characteristics for the spring-biased hinged assembly 10 are available to the user by selectively varying the profile of the spool 30. For example, a spool profile may be selected which allows the spring-biased hinged assembly to be retained in the open or “over-lock” position.

As would be appreciated by the skilled person in the art, selecting a spool profile which allows the spring-biased hinged assembly to be retained in the “over-lock” position is particularly advantageous when the spring-biased hinged assembly is applied to doors or gates which are required to remain open in a pre-determined position for a period of time. A typical example of such a use is the application of the spring-biased hinged assembly to a screen door, such as a fly screen door, so that the door may remain open whilst a high traffic of users pass through the doorway.

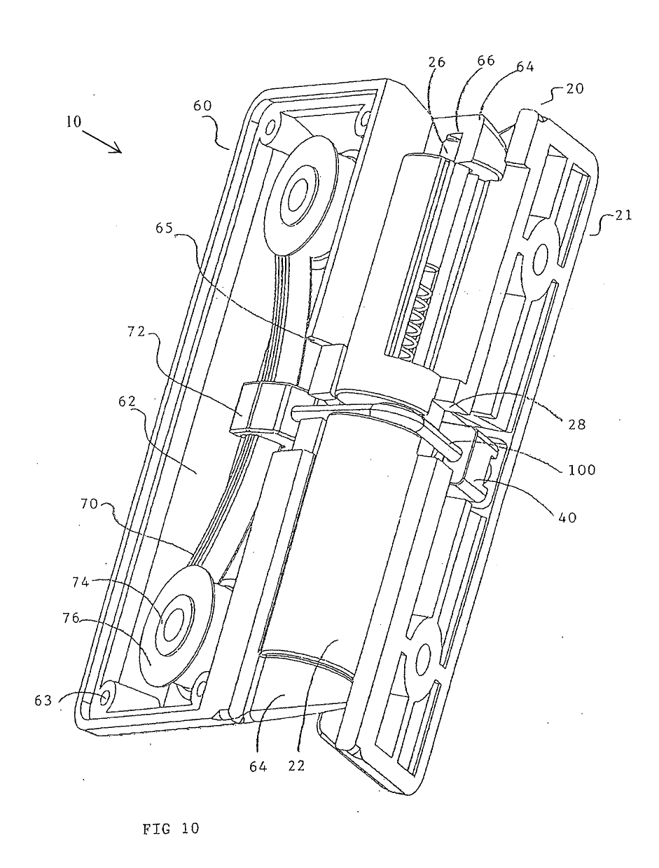

In accordance with the preferred embodiment of the present invention, FIG. 10 shows the spring-biased hinge assembly 10 in an open position, with respective first and second aperture mounting flanges removed for clarity.

As first hinged member 20 and second hinged member 60 articulate further apart, tensile member 100 wraps itself further about the spool (not shown) and the load on leaf spring 70 increases in the manner previously described.

In an alternative embodiment of the present invention not shown, the spool may be replaced with a lever arm on the first hinged member, intermediate the cylindrical chambers in a manner similar to that of the spool. In this embodiment, one end of the tensile member is fastened to the lever arm by any suitable known means, whilst the other end is passed through the opening in the second hinged member and fastened to the leaf spring retaining sleeve as previously described.

In this embodiment, the tensile member may be pre-tensioned, or the tension adjusted by tightening/loosening the tension in the tensile member when fastening it to the lever arm, or leaf spring retaining sleeve, rather than using the tensioning bolt and anchor block arrangement previously described.

The subsequent torque characteristics of the spring-biased hinged assembly 10 are a product of the resistive force provided by the leaf springs 70 and the effective length of the lever arm at the point at which the tensile member 100 contacts the lever arm.

By selectively varying the effective length of the lever arm, the torque characteristics of the spring-biased hinged assembly 10 may be controlled by the user in a manner similar to that described above.

FIG. 10 shows the tensile member 100 extending from leaf spring retainer sleeve 72 through opening 65, over the spool (not visible in FIG. 10) and through bore hole 28 into pre-tensioning chamber 40, whereby the tensile member 100 is located approximately in the longitudinal centre of the spring-biased hinge assembly 10.

In further embodiment, the tensile member 100 need not be located substantially medially in the spring-biased hinged assembly 10. That is, spool 30, whilst remaining intermediate to the cylindrical chambers 22, may be located closer to one end of the spring-biased hinged assembly. Accordingly, bore hole 28 and pre-tensioning chamber 40 are moved into axial alignment with the spool 30 and the length of cylindrical chambers 22 also adjusted appropriately. Similarly, opening 65 in housing 62 of the second hinged member 60 is also relocated to provide axial alignment, and leaf spring retaining sleeve 72 moved accordingly to provide a substantially linear path for the tensile member 100 between the first hinged member 20 and second hinged member 60.

In yet another alternative embodiment not shown, the first hinged member includes a single cylindrical chamber 22 having a spool 30 located at one end thereof. A hole is provided in the spool 30 which extends into the cylindrical chamber 22 in order to retain a compression spring 24 and locating pin 26 such that the location pin 26 protrudes from the spool 30 into recess 66 of the second hinged member 60 as previously described. In a manner similar to that described above, the pre-tensioning chamber 40, bore hole 28, opening 65 and leaf spring retaining sleeve 72 are subsequently re-aligned with the spool 30 in order to provide a substantially linear path for the tensile member 100 to extend from the first hinged member 20 to the second hinged member 60.

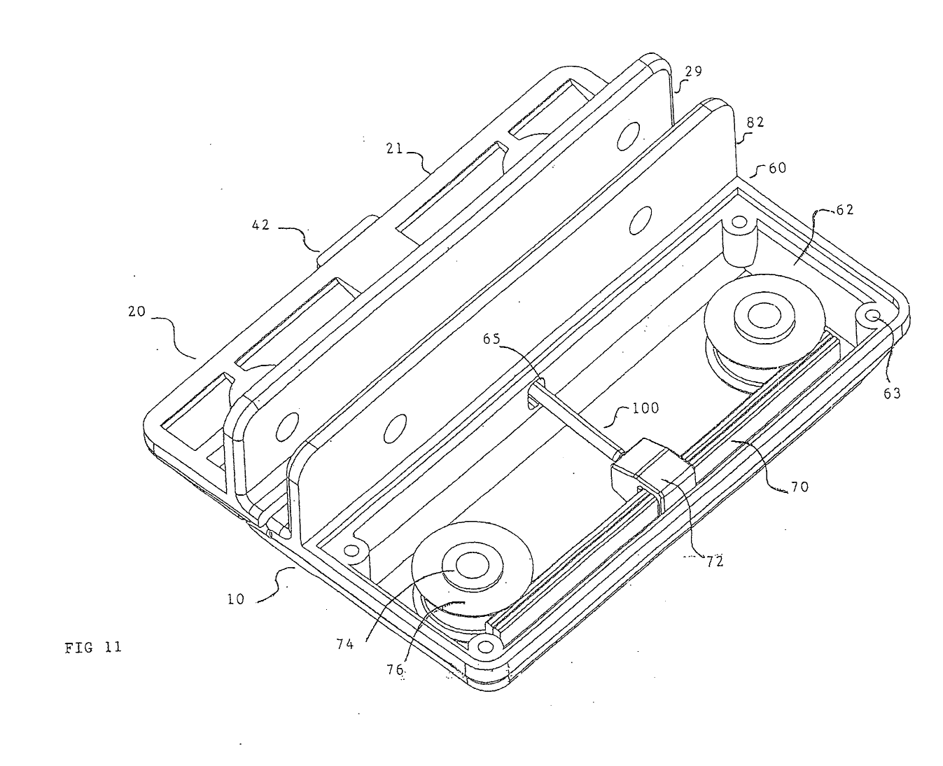

FIG. 11 shows the spring-biased hinge assembly 10 of the preferred embodiment in the closed position. As illustrated, the spring-biased hinge assembly is not pre-tensioned such that leaf springs 70 are pre-loaded or flexed prior to articulation between the first hinged member 20 and second hinged member 60.

In an alternative embodiment of the present invention, leaf springs 70 and leaf spring retaining sleeve 72 may be replaced with a compression spring mounted to housing 62 of the second hinged member 60 in any suitable manner. Additionally, bearings 76 may also be removed and the tensile member 100 fixed to the compression spring in any suitable manner. The remaining components of the spring-biased hinge assembly 10 may be used as previously described.

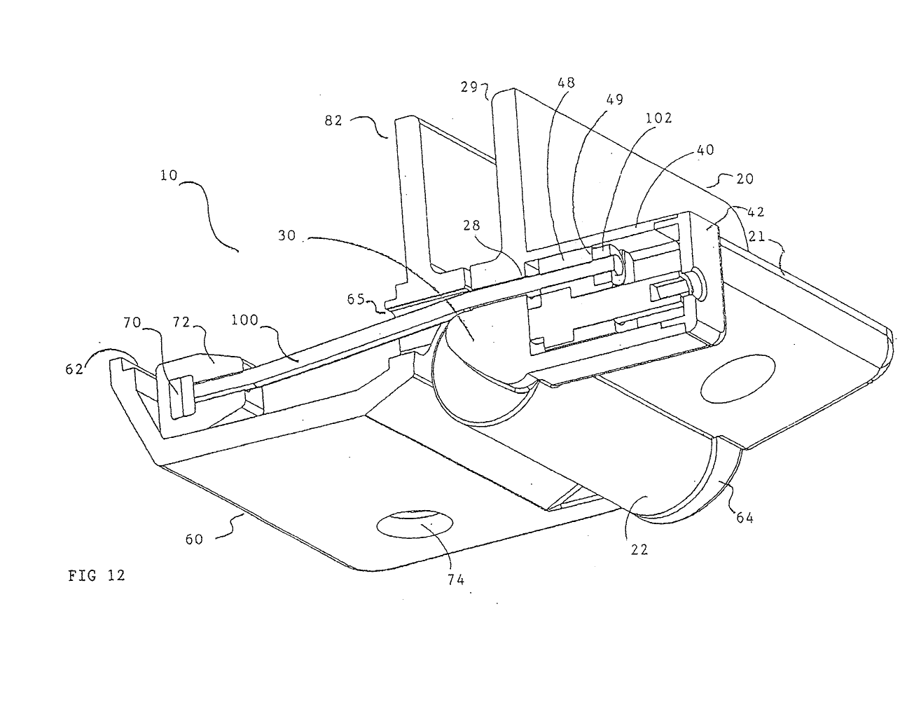

FIG. 12 shows a transverse cross section of the spring-biased hinge assembly 10 in the closed position. Anchor block 48 is located at the base of pre-tensioning chamber 40; consequently leaf springs 70 are in a relaxed state. In this embodiment spool 30 has a cammed profile which is offset from the central longitudinal axis of cylindrical chamber 22.

The cammed profile of spool 30 varies the radius of the spool at the tangential point at which the tensile member 100 contacts the spool 30 as the spring-biased hinged assembly 10 articulates. The torque characteristics of the spring-biased hinged assembly 10 are thereby varied such that as the spring-biased hinged assembly articulates from an open position to the closed position exponential torque characteristics are prevented and a substantially uniform torque is present.

FIG. 12 also shows the swage 102 of tensioning member 100 located on seat 49 of the anchor block 48. In an alternative embodiment, the tensioning member 100 may simply be secured to the anchor block 48 by way of a knot should a non-metallic tensile member be used. The other end of the tensile member 100 may be fastened to leaf spring retaining sleeve 72 by weaving the tensile member 100 through at least 2 holes (not shown) in the leaf spring retaining sleeve 72 and tied off. Alternatively, the tensile member may be fixed to leaf spring retaining sleeve 72 through any suitable means as would be understood in the art such as a grub screw or the like, located in a recess in the leaf spring retaining sleeve 72.

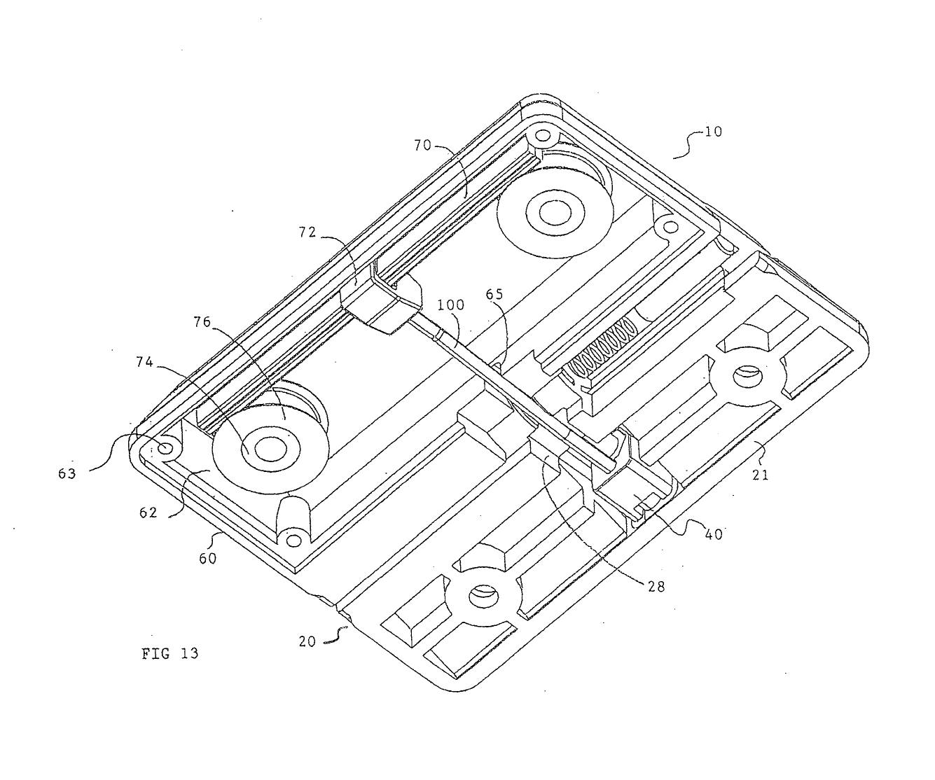

FIG. 13 shows a perspective view of the spring-biased hinged assembly 10 whilst in the closed position. First and second aperture mounting flanges have been removed for clarity. In this embodiment of the present invention, housing 62 includes an opening 65 in the form of a centrally located shallow channel on an edge of the housing 62. A second channel is cut to a depth in the base of the first shallow channel to allow tensile member 100 to be axially aligned so as to tangentially contact the spool (not visible) when the spring-biased hinged assembly 10 is in a closed position.

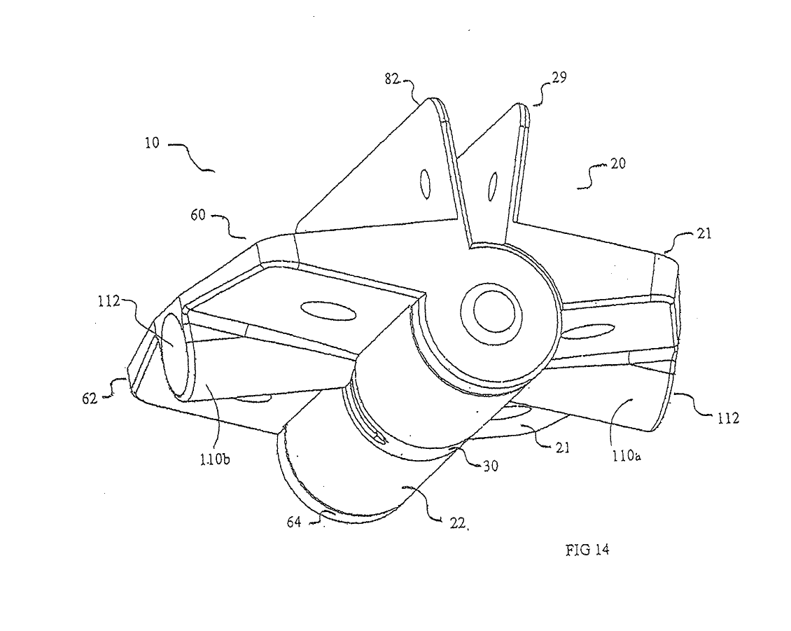

FIGS. 14-18 illustrate an alternative embodiment of the present invention. In this embodiment, the spring biased hinge assembly 10 includes a first hinged member 20 having an apertured base plate 21 and first apertured mounting flange 29 for mounting the first hinged member 20 to a structure as previously described.

First hinged member 20 further comprises a pair of cylindrical chambers 22 and a spool 30 intermediate cylindrical chambers 22. The first hinged member 20 also includes compression springs and locating pins (both not illustrated) to engage with the recess (not illustrated) of hinged plates 64 of the second hinged member 60 as previously described.

Second hinged member 60 comprises an apertured housing 62 and second apertured mounting flange 82 for mounting the spring biased hinge assembly 10 to a structure in the manner as previously described.

Additionally, first hinged member 20 includes a spring housing 110a for housing a compression spring 114a. The spring housing 110a includes a tunnel 118a sized to allow tensile member 100 to pass therethrough, yet not allow compression spring 114a therein. Similarly, second hinged member 60 includes a spring housing 110b to receive compression spring 114b. Spring housing 110b similarly includes a tunnel 118b, axially aligned with tunnel 118a of spring house 110a. The axial alignment of tunnels 118a and 118b allows tensile member 100 to pass from spring housing 110a in the first hinged member 20 to the spring housing 110b in the second hinged member 60. Each of the spring housings 110a, 110b are preferably fitted with housing caps 112 to close the respective spring housings and prevent debris from entering.

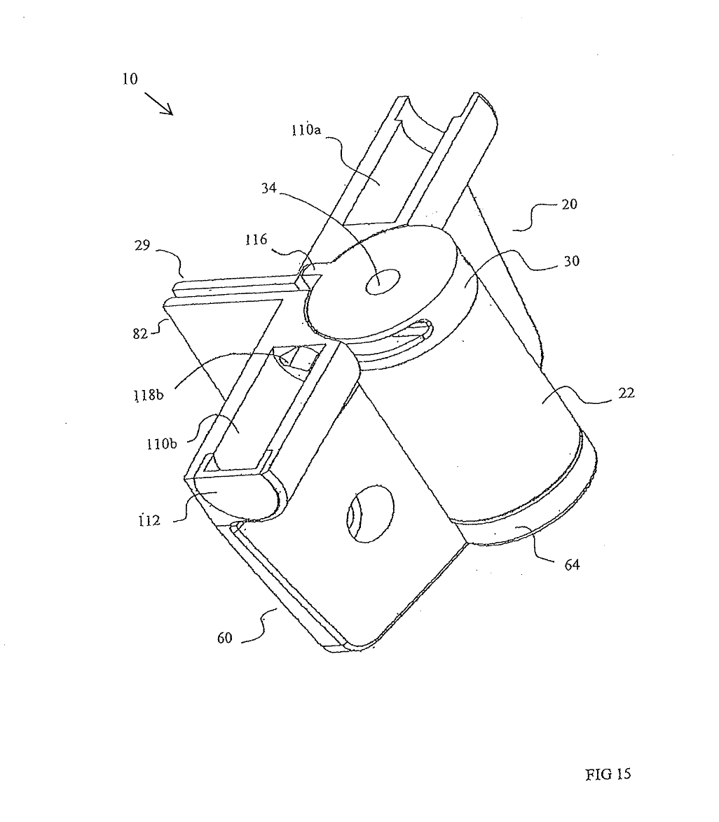

As seen from FIG. 15, spring biased hinge assembly 10 includes a spool 30 which rotates independently of the cylindrical chambers 22 as the first hinged member 20 articulates with respect to second hinged member 60. Spool 30 includes hole 34 therethrough to receive a pin or axle (not shown) in order to provide axial rotation for the spool 30.

In a preferred form, a centre pin (not illustrated) is of sufficient length to pass through hole 34 of the spool 30 and extend into the respective cylindrical chambers 22. Each cylindrical chamber also retains a locating pin 26, and compression spring 24 as illustrated in FIG. 3. The ends of the center pin are respectively fitted to the compression springs 24 at the end of the compression springs opposite to that receiving the locating pin 26 so that spool 30 rotates independently of the rotation applied to cylindrical chamber 22.

In another alternative embodiment, each cylindrical chamber 22 includes a bore hole at the end closest to spool 30. The bore hole contains a compression spring 24 and locator pin 26 similar to those previously described with respect to FIG. 3. Spool 30 is retained by each of the partially protruding locator pins 26 extending from the bore hole in each cylindrical chamber 22 into hole 34 of the spool 30. The spool is thereby able to rotate independently of any articulation of the spring-biased hinged assembly 10.

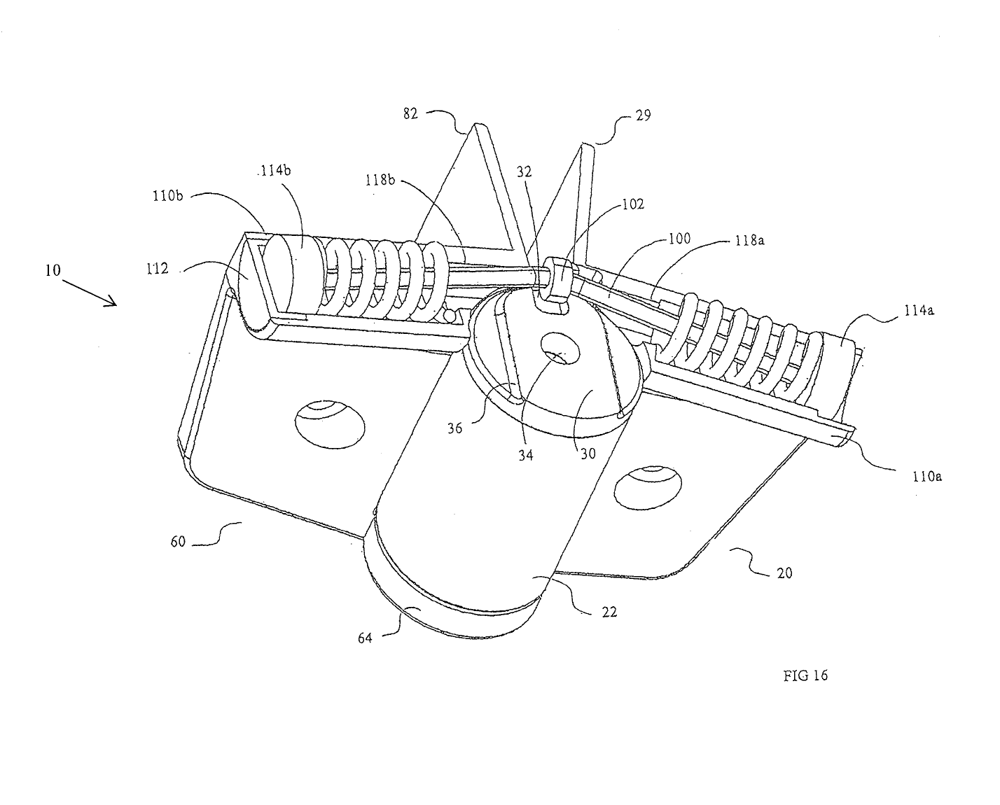

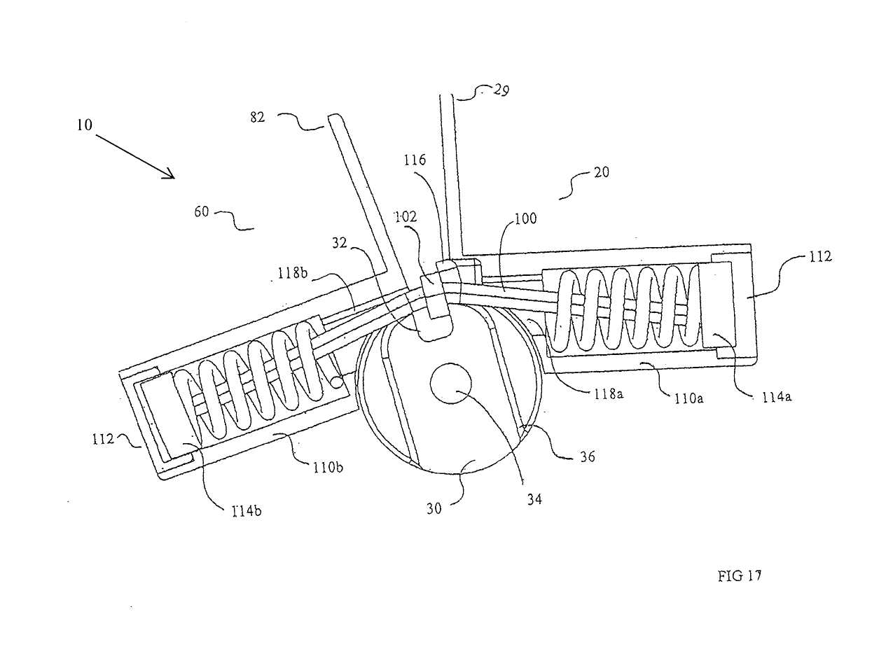

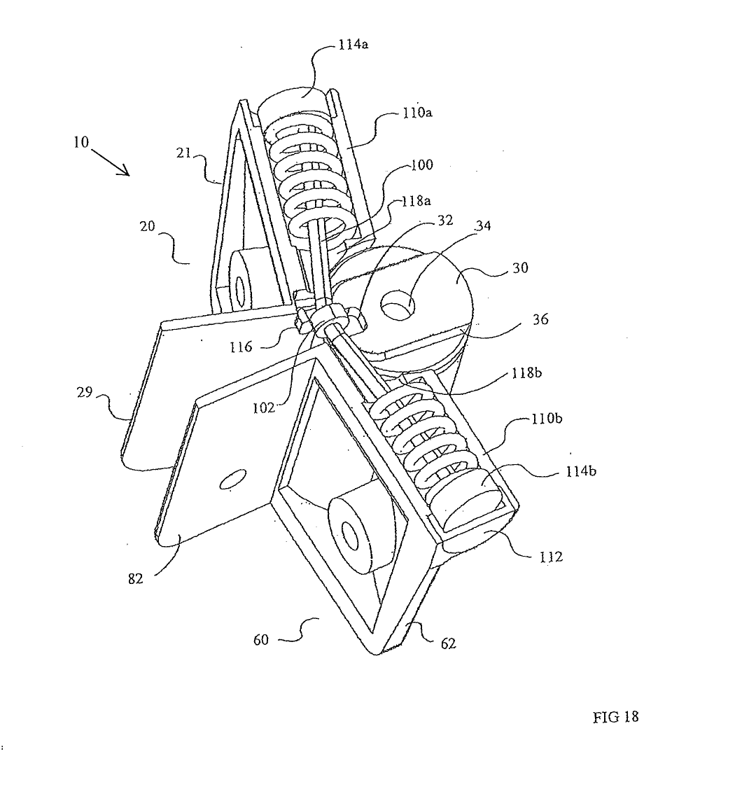

As illustrated in FIGS. 16-17, spool 30 also includes a swage recess 32 for receiving and retaining a swage 102 in place on the spool 30. The spool also includes a tensile support track 36 to assist tensile member 100 being located upon the spool surface 30 rather than abrading and slipping on the spool's surface as articulation of the spring-biased hinged assembly 10 occurs. The tensile member 100 is further prevented from axially misaligning itself through the use of an eyelet 116 formed on spool 30, as best illustrated in FIGS. 17-18.

As shown in FIGS. 16-18, each end of tensile member 100 is fixed to the distal ends of the respective compression springs 114a, 114b, and a swage 102 applied approximately half-way along the length of the tensile member 100. The swage is then retained in swage recess 32 of the spool 30. By adjusting the length of the tensile member 100 and/or swaging it at the appropriate length, the compression springs 114a, 114b may be pre-loaded to provide a closing torque between the first hinged member 20 and the second hinged member 60 whilst the spring biased hinged 10 assembly is in the closed position.

Pre-loading of the compression springs 114a, 114b ensures that the spring-biased hinged assembly 10 articulates back to the closed position for close-range closing of the spring biased hinge assembly. The torque characteristics can be selectively chosen by adjusting the length of the tensile member 100 prior to swaging and fitting the swage to swage recess 32, as well as by selecting different spool profiles as previously discussed.

In a preferred form of the present embodiment, the profile of spool 30 is such that as the first hinged member 20 and second hinged member 60 articulate open, spool 30 rotates approximately half the angle of rotation of the hinged members 20, 60 at any given point. That is to say, if first hinged member 20 is articulated to a position approximately 90° to the second hinged member 60, spool 30 rotates approximately 45° from its original position.

The independent rotation of spool 30 assists in tensile member 100 remaining in the tensile support track 36 thereby preventing the tensile member 100 slipping from, or abrading about the spool 30 as each of the compression springs 114a, 114b are loaded during articulation of the spring-biased hinged assembly 10. Advantageously, independent rotation of spool 30 further ensures that each of the compression springs 114a, 114b are loaded at the same rate so that the load is evenly distribution between each of the respective compression springs 114a, 114b as the spring-biased hinged assembly 10 articulates open.

As previously described, spool 30 may have multiple cam profiles in order to selectively control the torque characteristics of the spring biased hinge assembly 10 having compression springs 114a, 114b, as it articulates between the open and closed positions.

Additionally, the use of a compression spring 114a, 114b in each of first hinged member 20 and second hinged member 60 respectively allows a compact construction of the spring-biased hinged assembly 10 whilst advantageously maintaining the ability to selectively control the torque characteristics of the spring-biased hinged assembly. This advantageously allows the spring-biased hinged assembly of the present invention to be utilized where the size of a hinge is a critical design factor.

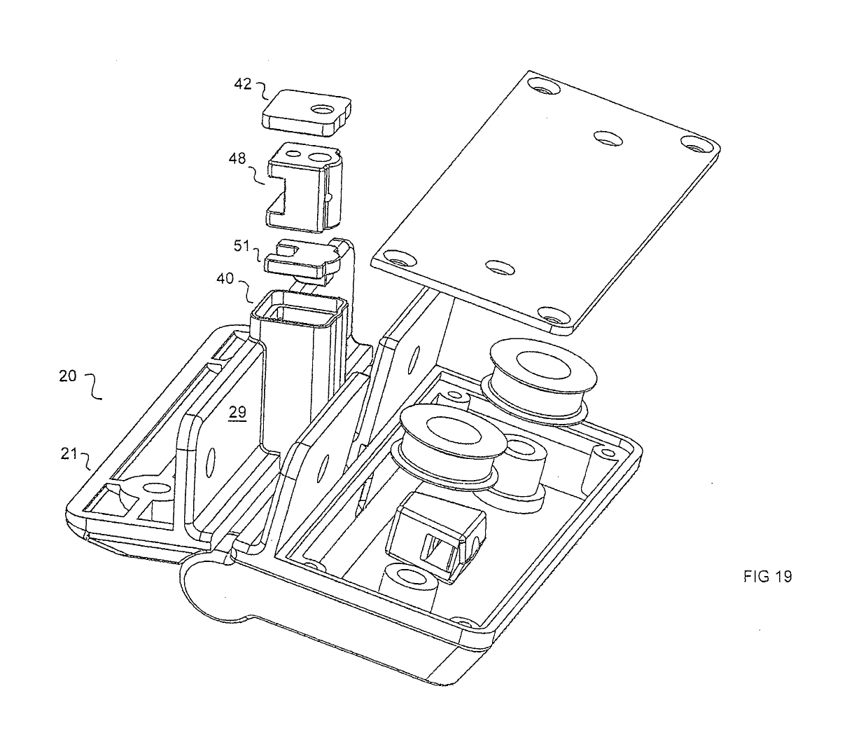

FIGS. 19-21 illustrate a further alternative embodiment of the present invention wherein the pre-tensioning chamber 40 is formed as part of the first aperture mounting flange 29, rather than aperture base plate 21 of the first hinged member 20, as previously illustrated in FIG. 6 for example. In use, the spring-biased hinged assembly 10, is mounted to a gate and fence such that the end cap 42 of the pre-tensioning chamber 40 faces inwards towards the region to be enclosed by the fence and gate.

This advantageously ensures that any adjusting of the tension on the tensile member (not shown) may only be undertaken by users within the enclosed gated region. Persons outside of the gated region are prevented from tampering with, or vandalsing the tensioning bolt and nut (not shown) within the pre-tensioning chamber 40 as they will not have access to pre-tensioning chamber 40 from their location outside of the enclosed region.

FIGS. 19-21 also show an exploded view of the elements within the pre-tensioning chamber 40 of this alternative embodiment. As previously described, the pre-tensioning chamber retains an anchor block 48 which receives a tensile member (not shown). End cap 42 prevents debris from entering the pre-tensioning chamber 40 as well as unwanted access to the anchor block 48. A transition block 51 having a transition radius 53 is retained in the pre-tensioning chamber 40 such that the tensile member (not shown) tracks over the transition radius 53 prior to advancing to the anchor block 48. By passing the tensile member over the transitional radius 53, the tensile member circumferentially tracks along the curve of the transition radius as the tension on the tensioning member is altered in the manner previously described. The transitional block 51 thereby prevents the tensile member from scrapping on an edge of the pre-tensioning chamber 40 and fraying. Running the tensile member along the transitional radius 53 also prevents wear points along the tensile member, thereby eliminating the possibility of the tensile member breaking.

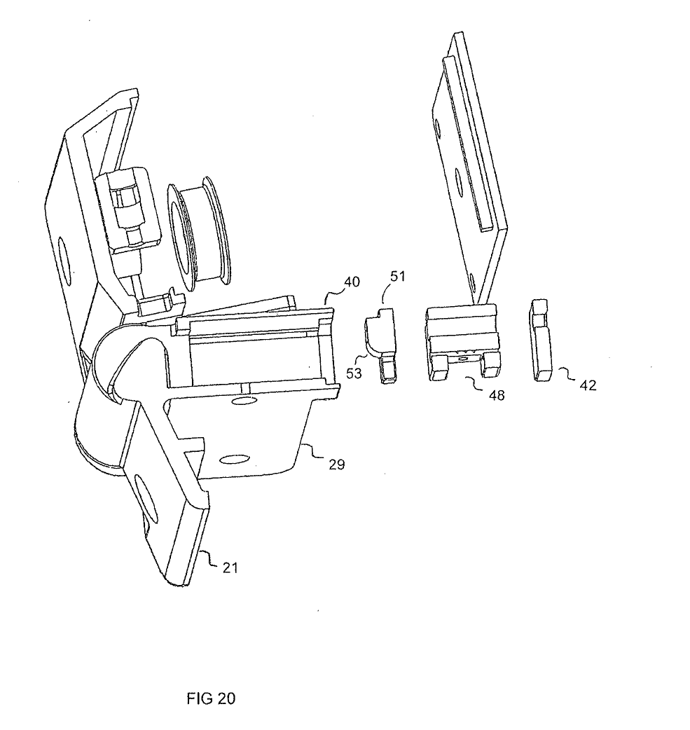

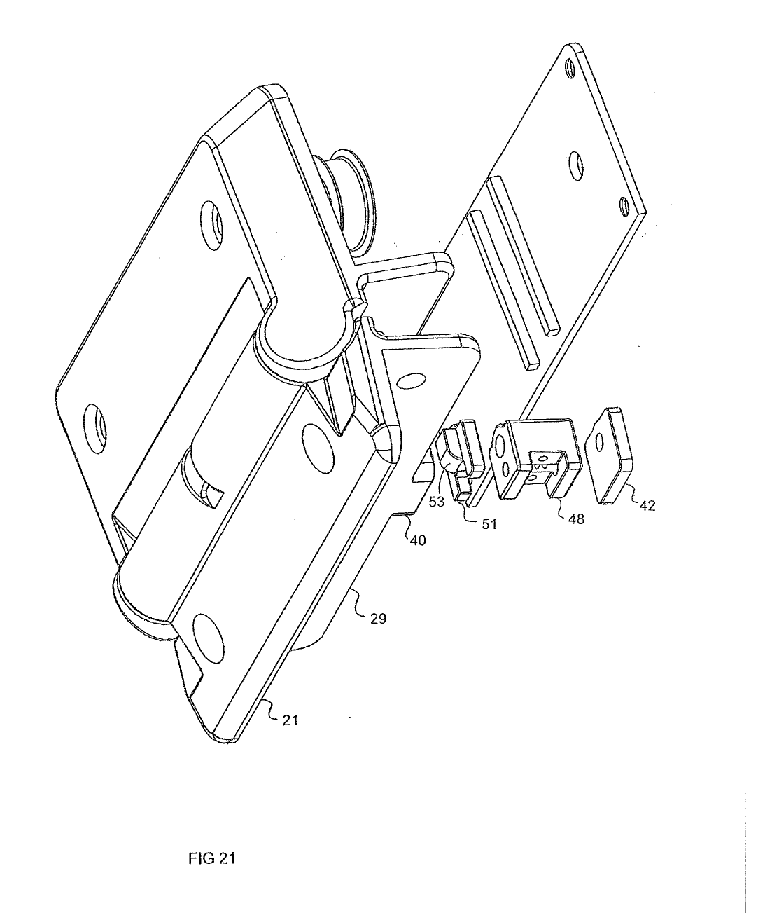

As best illustrated in FIGS. 20 and 21, the pre-tensioning chamber 40 can be integrally formed with the first mounting flange 29.

It will be readily understood by the skilled person that the remaining components of the spring-biased hinged assembly according to the embodiment shown in FIGS. 19-21 operate in the manner previously described.

Throughout this specification and the claims, unless the context requires otherwise, the word “comprise” and its variations, such as “comprises” and “comprising,” will be understood to imply the inclusion of a stated integer or step or group of integers or steps but not the exclusion of any other integer or step or group of integers or steps.

The reference to any prior art in this specification is not, and should not be taken as an acknowledgement or any form of suggestion that such art forms part of the common general knowledge in Australia.

1. A spring-biased hinged assembly comprising:
a spool associated with a first hinged member;
a spring associated with a second hinged member; and
a tensile member extending from the spool to the spring.

2. A spring-biased hinged assembly as claimed in claim 1, wherein the spool is non-cylindrical.

3. A spring-biased hinged assembly as claimed in claim 1, wherein the spool has an effective radius which decreases with increased articulation of the hinged assembly.

4. A spring-biased hinged assembly as claimed in claim 1, wherein articulation of the hinged assembly wraps the tensile member onto the spool and loads the spring.

5. A spring-biased hinged assembly as claimed in claim 4, wherein torque in the hinged assembly is a function of load on the spring and the effective radius of the spool at the point that the tensile member tangentially wraps onto the spool.

6. A spring-biased hinged assembly as claimed in claim 1, wherein the spring comprises a leaf spring.

7. A spring-biased hinged assembly as claimed in claim 6, wherein the leaf spring is mounted on a pair of spaced bearings.

8. A spring-biased hinged assembly as claimed in claim 7, wherein the pair of spaced bearings are concentric with a pair of mounting apertures in the second hinged member.

9. A spring-biased hinged assembly as claimed in claim 5, wherein the spring comprises a compression spring.

10. A spring-biased hinged assembly as claimed in claim 9, wherein the tensile member is fastened to a second spring associated with the first hinged member.

11. A spring-biased hinged assembly as claimed in claim 10, wherein the second spring is a compression spring.

12. A spring-biased hinged assembly as claimed in claim 9, wherein the spool rotates independently of the first hinged member and second hinged member.

13. A spring-biased hinged assembly as claimed in claim 1, wherein the tensile member is adjustably mounted to the first hinged member such that preload on the spring can be adjusted.

14. A spring-biased hinged assembly as claimed in claim 1, wherein the spool is integrally formed with the first hinged member.

15. A method of converting spring force into torque in a spring-biased hinged assembly, the method comprising:
providing a spool associated with a first hinged member;
providing a spring associated with a second hinged member;
providing a tensile member extending from the spool to the spring; and
articulating the hinged assembly in order to wrap the tensile member onto the spool.

16. A structure including a spring-biased hinged assembly comprising:
a spool associated with a first hinged member;
a spring associated with a second hinged member; and
a tensile member extending from the spool to the spring.

17-28. (canceled)

29. The method as claimed in claim 15, wherein an effective radius of the spool decreases at an interface with the tensile member with increasing articulation of the hinged assembly.

30. The method as claimed in claim 29, wherein articulating the hinged assembly and wrapping the tensile member onto the spool includes loading the spring.

31. The method as claimed in claim 30 comprising generating torque in the hinged assembly as a function of the load on the spring and the effective radius of the spool at the interface with the tensile member.

32. The structure as claimed in claim 16, wherein torque in the spring-biased hinged assembly applied to one or more of the first or second hinged members is a function of load on the spring applied through rotation of the first hinged member relative to the second hinged member and an effective radius of the spool at the point that the tensile member tangentially wraps onto the spool.
